(19) United States
(12) Patent Application Publication
(10) Pub. No.: US 2003/0030240 A1
(43) Pub. Date: Feb. 13, 2003

(54) Structure of a golf bag

(76) Inventor: Ching-Chi Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/925,462

(22) Filed: Aug. 10, 2001

(51) Int. Cl. B62B 1/00; A63B 55/00

(52) U.S. Cl. 280/47.315

(57) ABSTRACT

An improved structure of a golf bag is disclosed. The golf bag includes a pulling shaft device and a roller device located at an appropriate position on the bag. The roller device can be dissembled from the bag body and the pulling shaft device is mounted at a mounting cylinder provided to the bag body. Screw nuts and a U-shaped clipping member are used to mount the roller device onto the bottom section of the golf bag, thereby, the golf bag can be easily and conveniently dragged to move by extending the shaft device to an appropriate length for pulling.

### BACKGROUND OF THE INVENTION

(a) Field of the Invention

The present invention relates to an improved structure of a golf bag, and in particular, a golf bag having mounted with a pulling shaft device and a roller device facilitating the movement and transporting of the golf bag.

(b) Description of the Prior Art

Handling and transporting larger and heavier golf bags has become a problem for golfers. In particular, transporting the golf bag from the house to the car and from the car to the golf cart has become a major evolution, especially for senior citizens who may not have the physical strength necessary for such a task. For longer distances transportation, such as those which would occur in an airport or in train station, transporting the golf bag is a strenuous task prior to the beginning of the game.

Another segment of the golfers would prefer to transport their bag around the course for the exercise. This is often a physical impossibility due to the size and weight of the bag.

### SUMMARY OF THE INVENTION

Accordingly, it is an object of the present invention to provide an improved structure of a golf bag, which mitigates and solves the drawbacks of the conventional golf bag.

Yet another object of the present invention to provide an improved structure of a golf bag, wherein the pulling shaft device and the roller device upgrades the functionality of the golf bag such that the golf bag can be easily moved from one place to another.

An aspect of the present invention is to provide an improved structure of a golf bag, wherein the roller device includes a roller shaft and nuts and a U-shaped clipping member with an anti-skip pad being mounted to the bottom section of the bag body.

A further aspect of the present invention is to provide an improved structure of a golf bag, wherein the pulling shaft device and the roller device are directly mounted at the bag body forming into a fixed pulling shaft device and the roller device.

### BRIEF DESCRIPTION OF THE DRAWINGS

FIG. 1 a perspective view of an improved structure of a golf bag of the present invention.

FIG. 2 is a perspective view of a second preferred embodiment of the present invention.

FIG. 3 is a schematic view showing the retraction of the pulling shaft device of the present invention.

FIG. 4 is a schematic view of the second preferred embodiment, showing the retraction of the pulling device of the present invention.

FIG. 5 is a perspective view showing the roller device with a single roller shaft of the first preferred embodiment of the present invention.

FIG. 6 is an exploded perspective view showing the roller device prior to mounting to the bag body of the present invention.

FIG. 7 is a perspective view of the roller device of the second preferred embodiment.

FIG. 8 is a perspective exploded view of the roller device of the second preferred embodiment.

### DETAILED DESCRIPTION OF THE PRESENT INVENTION

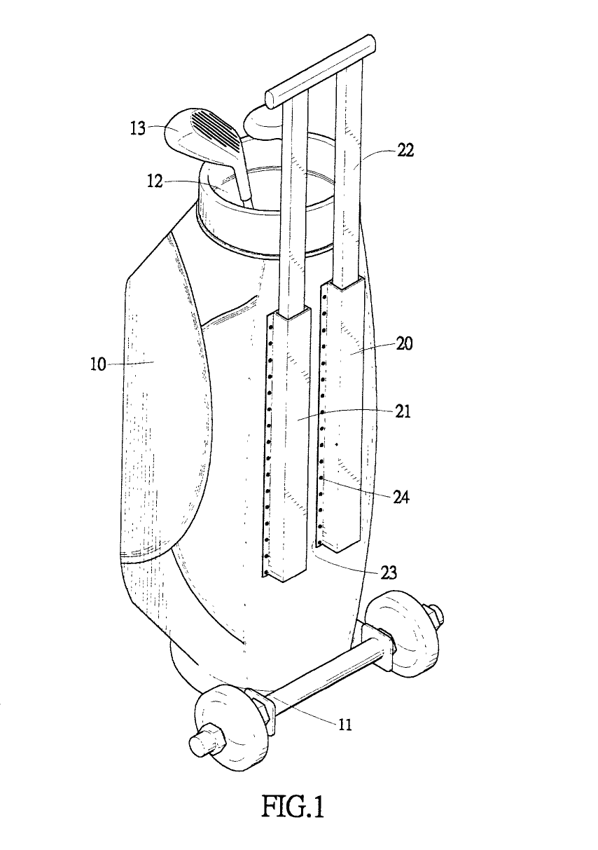

Referring to FIGS. 1 to 5, there is shown an improved structure of a golf bag having a body 10 mounted with a pulling shaft device 20 and a roller device 30 which can be dissembled.

As shown in the figures, the bag body 10 includes a circular base seat 11 at the bottom thereof, and an opening 12 at the top thereof, along the placement of a plurality of clubs 13.

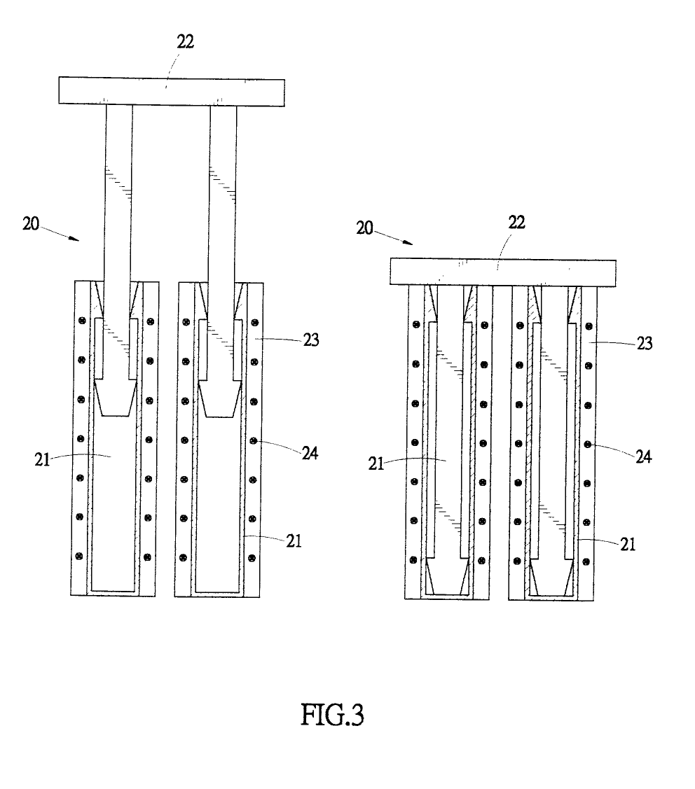

Referring to FIGS. 1 and 3, there is shown a first preferred embodiment of the present invention, wherein the pulling shaft device 20 includes a pair of mounting cylinders 21 fastened to the bag body 10; and a U-shaped pulling shaft 22 retractable within the mounting cylinders 21, and the lateral sides of the mounting cylinders 21 are provided with protruded side 23, and a plurality of fastening members 24 are used to mount the mounting cylinders 21 onto the bag body 10, and the end terminal of the U-shaped pulling shaft 22 is mounted at the mounting cylinders 21 without dislocating thereof. This is shown in FIG. 3.

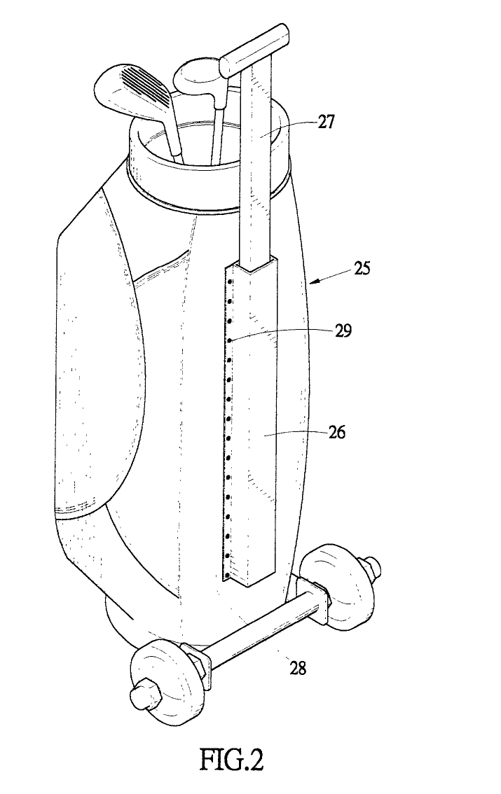

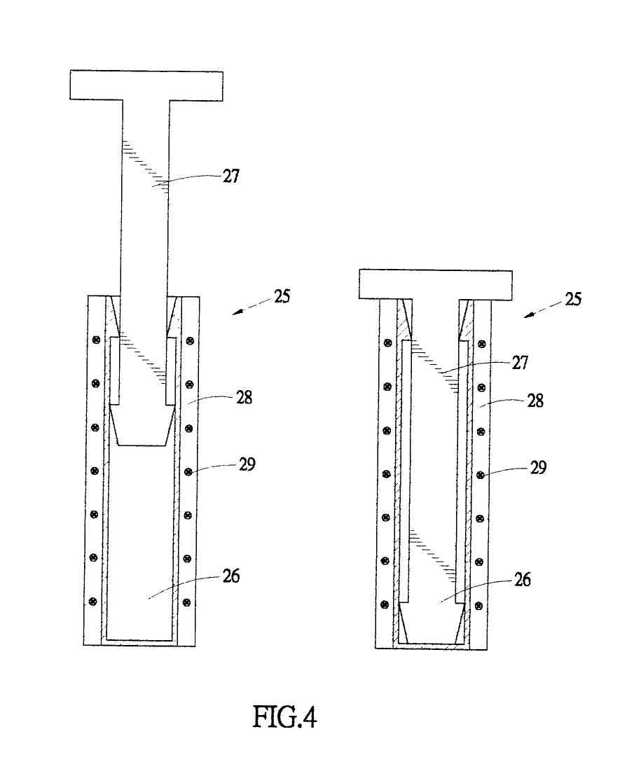

Referring to FIGS. 2 and 4, there is shown a second preferred embodiment of the present invention. The pulling device 25 includes a single mounting cylinder 26; and a T-shaped pulling shaft 27 retractable within the mounting cylinders 26, and the lateral sides of the mounting cylinders 26 are provided with protruded side 28, and a plurality of fastening members 29 are used to mount the mounting cylinders 26 onto the bag body 10, and the end terminal of the T-shaped pulling shaft 27 is mounted at the mounting cylinders 26 without dislocating thereof. This is shown in FIG. 4.

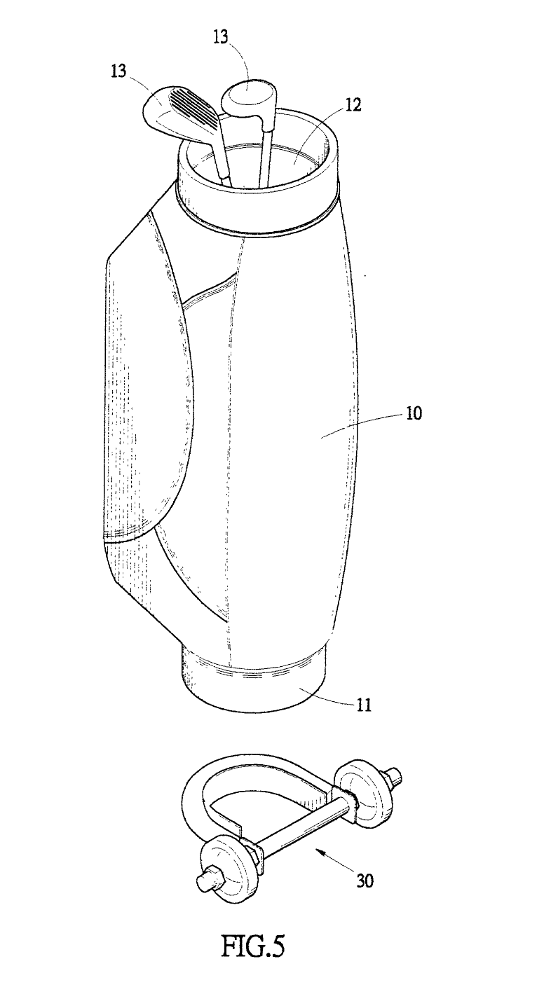

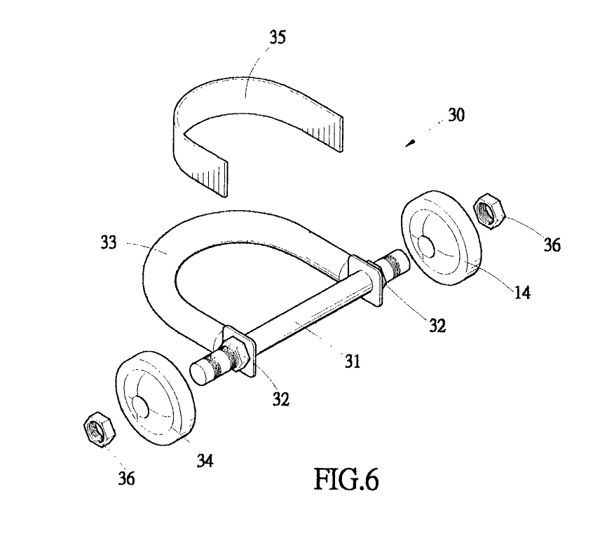

Referring to FIGS. 5 and 6, there is shown the roller device of the first preferred embodiment. The roller device 30 includes a roller shaft 31, a U-shaped clipping member 33; and a pair of rollers 34, wherein the two ends of the U-shaped clipping member 33 are mounted to the two ends of the roller shaft 31, and a pair of nuts 32 respectively fasten the two ends of the U-shaped clipping member 33 externally at the roller shaft 31, the two rollers 34 are mounted at the two ends of the roller shaft 31 and are positioned by nuts 36, and an anti-skip pad 35 is positioned within the edge face of the U-shaped clipping member 33 contacting the base seat 11 of the bag body 10.

By fastening the nuts 32, the roller device 30 is secured to the bag body 10, or by loosening the nuts 32, the roller device 30 can be dislocated.

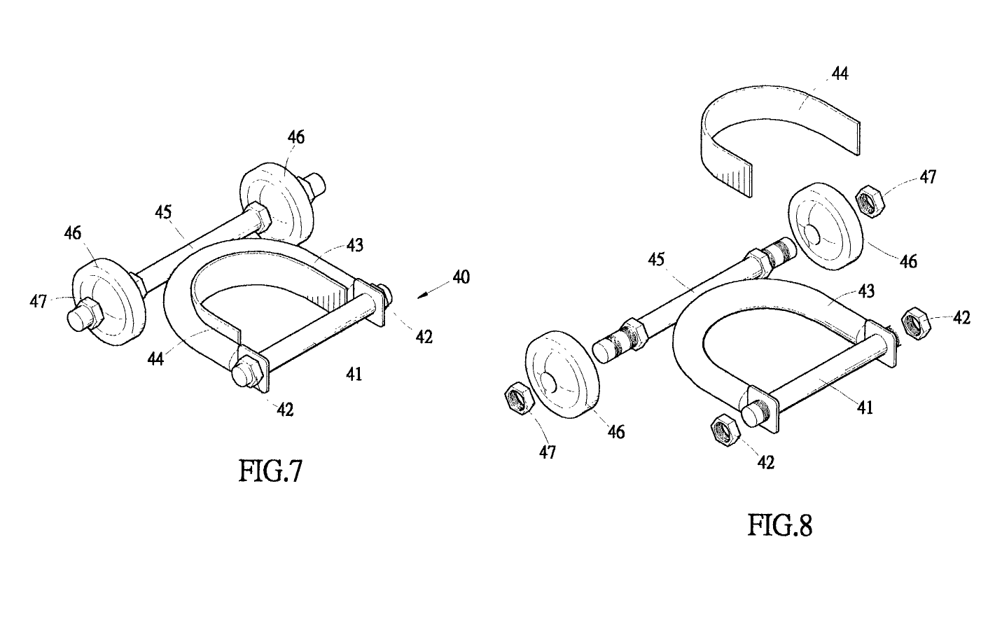

Referring to FIGS. 7 and 8, there is shown the roller device of the second preferred embodiment of the present invention.

The roller device 40 includes a first roller shaft 41; a U-shaped clipping member 43; a second roller shaft 45 and a pair of rollers 46, wherein the two ends of the U-shaped clipping member 43 are mounted to the two ends of the first roller shaft 41, and a pair of nuts 42 respectively fasten the two ends of the U-shaped clipping member 43 externally, the second roller shaft 45 is welded at the center section of the U-shaped end of the clipping member 43 and is parallel to the first roller shaft 41, the two rollers 46 are positioned at the two ends of the second roller shaft 45 and are positioned by two nuts 47, and an anti-skip pad 44 is positioned within the edge face of the U-shaped clipping member 43 contacting the base seat 11 of the bag body 10.

By tightening the two nuts 42 the roller device 40 is secured to the bag body 10 or by loosening of the two nuts 42, the roller device 40 is dislocated from the bottom portion of the bag body 10.

In accordance of the present invention, the pulling device 20 or 25, the roller device 30 or 40 and mounted at the bag body 10, and the pulling shaft of the pulling shaft device is hidden within the mounting cylinder. The user can move the golf bag by dragging the pulling shaft after it is extended from the mounting cylinder.

The pulling shaft device of the first preferred embodiment 20, the second preferred embodiment 25, the roller device of the first preferred embodiment 30, the second preferred embodiment 40 are replaceable with each other to mount at the bag body 10, and similar effectiveness is obtained.

Accordingly, the improved structure of a golf bag facilitate a heavy golf bag to be dragged and moved easily and allowing the accessible of the clubs conveniently.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

1. An improved structure of a golf bag comprising
(a) a bag body having a circular base seat and a circular opening on the top thereof, and a plurality of clubs being inserted from the opening to the bag body;
(b) a pulling shaft device mounted at the external of the bag body and including a mounting cylinder and a pulling shaft located within the mounting cylinder, allowing a retraction of the pulling shaft; and
(c) a roller device foldable mounted onto the base seat at the bottom of the bag body and including at least a pair of rollers, a roller shaft and a clipping member to clip onto the base seat so as to fasten the roller device onto the bag body; thereby, the pulling shaft can be pulled and the roller at the base seat facilitates the movement of the golf bag.

2. The improved structure of a golf bag of claim 1, wherein
the pulling shaft device includes a pair of mounting cylinders fastened to the bag body; and
a U-shaped pulling shaft retractable within the mounting cylinders, and the lateral sides of the mounting cylinders are provided with protruded side, and a plurality of fastening members are used to mount the mounting cylinders onto the bag body, and the end terminal of the U-shaped pulling shaft is mounted at the mounting cylinders without dislocating thereof.

3. The improved structure of a golf bag of claim 1, wherein
the pulling shaft device includes
a single mounting cylinder; and
a T-shaped pulling shaft retractable within the mounting cylinders, and the lateral sides of the mounting cylinders are provided with protruded side, and a plurality of fastening members are used to mount the mounting cylinders onto the bag body, and the end terminal of the T-shaped pulling shaft is mounted at the mounting cylinders without dislocating thereof.

4. The improved structure of a golf bag of claim 1, wherein
the roller device includes
a roller shaft,
a U-shaped clipping member; and
a pair of rollers, wherein the two ends of the U-shaped clipping member are mounted to the two ends of the roller shaft, and a pair of nuts respectively fasten the two ends of the U-shaped clipping member externally at the roller shaft, the two rollers are mounted at the two ends of the roller shaft and are positioned by nuts, and an anti-skip pad is positioned within the edge face of the U-shaped clipping member contacting the base seat of the bag body.

5. The improved structure of a golf bag of claim 1, wherein
the roller device includes
a first roller shaft;
a U-shaped clipping member;
a second roller shaft and a pair of rollers, wherein the two ends of the U-shaped clipping member are mounted to the two ends of the first roller shaft, and a pair of nuts respectively fasten the two ends of the U-shaped clipping member externally, the second roller shaft is welded at the center section of the U-shaped end of the clipping member and is parallel to the first roller shaft, the two rollers are positioned at the two ends of the second roller shaft and are positioned by two nuts, and an anti-skip pad is positioned within the edge face of the U-shaped clipping member contacting the base seat of the bag body.

6. The improved structure of a golf bag of claim 1, wherein the pulling shaft device and the roller device are directly mounted at the bag body forming into a fixed pulling shaft device and the roller device.
